(19) United States
(12) Patent Application Publication
(10) Pub. No.: US 2024/0373867 A1
(43) Pub. Date: Nov. 14, 2024

(54) GRAIN TREATMENT

(71) Applicant: ARDENT MILLS, LLC, Denver, CO (US)

(72) Inventor: Christopher Lee MILLER, Wamego, KS (US)

(21) Appl. No.: 18/691,380

(22) PCT Filed: Sep. 13, 2022
(86) PCT No.: PCT/US2022/076370

§ 371 Date: Mar. 12, 2024

Related U.S. Application Data
(60) Provisional application No. 63/243,490, filed on Sep. 13, 2021.

(51) Int. Cl. A23B 9/06; A23L 3/00; A23L 3/28; B02B 1/02; G07F 13/00

(52) U.S. Cl. CPC A23B 9/06; A23L 3/001; A23L 3/28; B02B 1/02; G07F 13/00

(57) ABSTRACT

In examples, a material, such as raw or processed grain, may be dispensed (e.g., by a vibratory feeder) and charge associated therewith may be neutralized (e.g., by an ion generator). The material may then be suspended within a fluid flow. The fluid flow may pass through a treatment chamber, where material suspended therein is exposed to one or more light sources. The light sources may emit UVB, UVC, and/or VUV light, which may have germicidal and/or photocatalytic effects. In some examples, the flow is carried through the treatment chamber by a quartz tube, which may be doped or the interior of which may be coated by titanium dioxide. As an example, when the titanium dioxide is exposed to the UVB light, an oxidation reaction may occur, which may have germicidal, cleaning, and/or odor-reducing effect,. among other examples. The treated material may ultimately settle out of the flow and be collected.

### BACKGROUND

Grain and grain products are significant and important human food resources and livestock feeds worldwide. The main cereal grains used for foods include corn (maize), wheat, barley, rice, oats, rye, millet, and sorghum. Soybeans are not a cereal product, but rather, are legumes or a pulse, but are often considered with cereals because of their importance as a food source. Examples of products derived from grains include wheat, rye, and oat flours and semolina, cornmeal, corn grits, doughs, breads, breakfast cereals, pasta, snack foods, dry mixes, cakes, pastries, and tortillas. In addition, grain products are used as ingredients in numerous products including batters, coatings, thickeners, sweeteners, processed meats, infant foods, confectionary products, and beverages.

Microbial and bacterial contamination of both raw and processed grains is both burdensome and expensive. In the milling process, prevention and reduction of microbial or bacterial contamination are extremely important, but unfortunately can add significant cost to production. The sources of microbial contamination of grains include the environment in which grains are grown, handled, and processed. Microorganisms that contaminate processed and unprocessed grains may originate from air, dust, soil, water, insects, rodents, birds, animals, humans, containers (shipping and storage), and equipment (handling and processing). Environmental factors that influence microbial contamination of grains include rainfall, drought, humidity, temperature, sunlight, frost, soil conditions, wind, insect, bird and rodent activity, harvesting equipment, use of chemicals in production, storage and handling, and moisture control. Hence, a need exists for techniques to reduce microorganisms and alter the physical properties of human and animal food and ingredients

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to techniques for grain treatment. In examples, a material, such as raw or processed grain, may be dispensed (e.g., by a vibratory feeder) and charge associated therewith may be neutralized (e.g., by an ion generator). The material may then be suspended within a fluid flow. The fluid flow may pass through a treatment chamber, where material suspended therein is exposed to one or more light sources. The light sources may emit UVB, UVC, and/or VUV light, which may have germicidal and/or photocatalytic effects. In some examples, the flow is carried through the treatment chamber by a quartz tube, which may be doped or the interior of which may be coated by titanium dioxide. As an example, when the titanium dioxide is exposed to the UVB light, an oxidation reaction may occur, which may have germicidal, cleaning, and/or odor-reducing effects, among other examples. The treated material may ultimately settle out of the flow and be collected.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system for grain treatment according to aspects described herein.

FIG. 2 illustrates an overview of an example exposure sensor according to aspects described herein.

FIG. 3 illustrates an overview of an example block diagram for dispensing material using a dispersion controller according to aspects described herein.

FIG. 4A illustrates a cross section of an example treatment chamber according to aspects described herein.

FIG. 4B illustrates a side view of an example treatment chamber and atmospheric control assembly according to aspects described herein.

FIGS. 5A-5C illustrate overviews of example flow control assemblies that may be used to control the flow of material into a treatment chamber according to aspects described herein.

FIG. 6 illustrates an overview of an example method for treating grain according to aspects described herein.

FIG. 7 illustrates an example of a suitable operating environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Raw grains treated according to aspects described herein include any grain, seed, berry or nut, harvested for the purpose of consumption by humans or animals. Raw grains may be consumed without further processing or may be stored for further processing into ingredients or food products. Examples of raw grains include, but are not limited to, wheat, maize, sorghum, oats, soy, barley, rice.

Processed grains treated according to aspects described herein include any raw grain that is further processed to produce an ingredient or finished foodstuff intended for the consumption by humans and animals in the processed form or as a component of a food formulation. Examples of processed grains include, but are not limited to, wheat flour, maize meal, sorghum meal, sprouted grains, flaked grains, porridges, and extruded, baked or fried goods. The instant invention may also be used on any type of flour production known.

Other materials that may be treated according to aspects described herein include, but are not limited to edible portions of food products not originating from raw or processed grains, such as plant fibers, dairy, poultry, meat or inorganic material.

In other examples, aspects disclosed herein may be used at any point in the production of edibles including in the harvest storage area, the processing and ingredient stage, packaging and with the finished product. Human and Animal Foods, as used herein, refer to any food product produced for the purpose of consumption by humans or animals. Examples include, but are not limited to, baked or extruded goods, porridges, fried foods and cooked or canned wet foods.

Ingredients, as used herein, refer to any edible materials used in food formulations for the purpose of producing human or animal food products. Ingredients may include raw and processed grains in addition to other materials and are the required components in a human or animal food. Examples include but are not limited to raw or processed grains, other materials, enzymes, fats, emulsifiers, salts, sugars, leavening agents and preservatives. Ingredients may be found in dry or liquid forms.

Microorganisms, as used herein, refer to any natural living pathogenic or non-pathogenic organism or spore found on the surface or internally to a raw or processed grain, food, ingredient or other material. Microorganisms may be present due to normal symbiotic or pathogenic growth conditions. Microorganisms may be present due to handling, transportation, non-intentional or intentional contamination and adulteration or by unknown factor. Examples include, but are not limited to, any pathogenic bacteria known or unknown such as E. coli, Salmonella, certain fungi such as Fusarium spp., Bacillus spp. and many others.

Mycotoxins, as used herein, refer to compounds and secondary metabolites produced by molds, fungi or other microorganisms, which are toxic when consumed by humans and animals.

Physical properties, as used herein, refer to characteristics of raw grains and processed grains including, but not limited to, color, appearance, texture, protein structure and function, absorptive properties of starch and other physical properties that may improve further processing of the material.

Stored product insects, as used herein, refer to any insect or pest (including eggs and larvae), which feed on or otherwise inhabit raw or processed grains. Examples include, but are not limited to, flour beetles, drugstore beetles, Indian meal moths, sawtoothed beetles, grain borers, and the like.

Treated material, as used herein, refers to any material, food, ingredient or edible portion of any human or animal food being treated according to aspects described herein, for example with ultraviolet (UV) light of any wavelength for the purpose of controlling microorganisms, altering physical properties, or enhancing separation from like materials using autofluorescence.

The current invention addresses numerous issues with the prior art and includes the utilization of the germicidal and photocatalytic effects of ultraviolet light with varying wavelengths and under standard or altered atmospheric conditions. Also described in this invention is a method for altering the physical properties of raw and processed grains or other materials used in human and animal food and ingredients. This method may be used in conjunction with or separately with any other method or device described herein, with the added purpose of modifying the physical properties of the treated materials.

In certain food products, bleaching agents and maturing agents may be added to improve the visual appearance (whiteness) and functional properties of the ingredient. Examples of these agents include benzoyl peroxide, chlorine gas, and potassium bromate. Bromate has been banned from use in food by most nations except the U.S., and is a suspected carcinogen. The use of deadly chlorine gas for wheat flour modification is still a common practice, but food companies have long sought a safer alternative.

In some examples, the application of UVC light (100 nm-280 nm) and VUV light (10 nm-200 nm) in a modified (e.g., oxygen-free) atmosphere may produce whitening through photo-bleaching and may act as a non-selective oxidizer to enhance the natural aging processes. The use of UVC and VUV light for improved color and functionality may be preferred, since no added ingredients and residues are left in the finished product. When the desired outcome is color enhancement and improved functionality, the modified atmosphere may be maintained precisely to maximize the intended result.

Also described in this invention is a method for increasing mortality in stored product insects of raw and processed grains or other materials used in human and animal food and ingredients. This method may be used in conjunction with or separately with any other method or device described herein, with the added purpose of controlling growth and activity in stored product insects common in raw and processed grains.

Stored product insects are a significant source of financial and physical material loss for raw and processed grains and ingredients. Many methods for controlling insects have been employed including fumigation with insecticides, physical destruction through impact devices and, removal through sieving. The germicidal effects of UVC light are similarly lethal to insects, particularly in the egg and larval stages. Thus, according to aspects described herein, raw grains may be exposed to UVC light (e.g., before storage) and, similarly, processed grains may be exposed to UVC light (e.g., during packaging), thereby increasing mortality in stored product insects and improving storability while also reducing the associated losses.

Also described in this invention is a method for mitigating mycotoxins in raw and processed grains or other materials used in human and animal food and ingredients. This method may be used in conjunction with or separately with any other method or device described herein, with the added purpose of mitigating mycotoxins in raw and processed grains and ingredients by altering the UV wavelength to include very short wave UV bulbs in the VUV (10 nm-200 nm) range of the spectrum. UV light in this range of the spectrum will result in photocatalytic oxidation including the production of ozone from atmospheric oxygen.

The most common application of VUV light is for fire restoration and elimination of odors such as smoke from air. In this application, VUV light reacts with and converts atmospheric oxygen to produce ozone, which then acts as a strong oxidizer in secondary reactions. The absorption of VUV light by oxygen and ozone is nearly complete, and essentially zero VUV light reaches the treated surface for continued direct reaction.

VUV light in a modified atmosphere (containing no oxygen), including but not limited to a nitrogen rich environment, ozone will not be produced and the full intensity of VUV light is emitted onto the surface of the treated material. Under these modified conditions, the photocatalytic effects of VUV light can be used to alter the chemical structure of mycotoxins and mitigate the toxicity of raw and processed grains containing mycotoxins.

For certain processes such as odor elimination in raw and processed grains, a range of ozone reactivity and photo-reactivity may be desired, and therefore the concentration of oxygen and nitrogen can be closely monitored in some instances to maintain control over reactivity level.

In some instances, UVB light (280 nm-315 nm) may be used in conjunction with titanium dioxide (TiO₂), such that emitted UVB radiation causes an oxidation reaction to occur. This oxidation reaction may maintain the cleanliness of components described herein. The oxidation may have germicidal effects and may further serve to reduce or inhibit odors (e.g., as a result of oxidizing one or more thiol groups that form from other aspects of the described treatment process). In some instances, the oxidation may facilitate aging of the material, which may be desirable in some instances.

Thus, aspects described herein may be used to control microorganisms in raw and processed grains or other materials, as may be used in human and animal food and ingredients. For example, properties of ultraviolet light (e.g., with UVC germicidal wavelengths) may be used to improve the safety, storability and quality of raw and processed grains and the ingredients commonly used in the production of both human and animal foods.

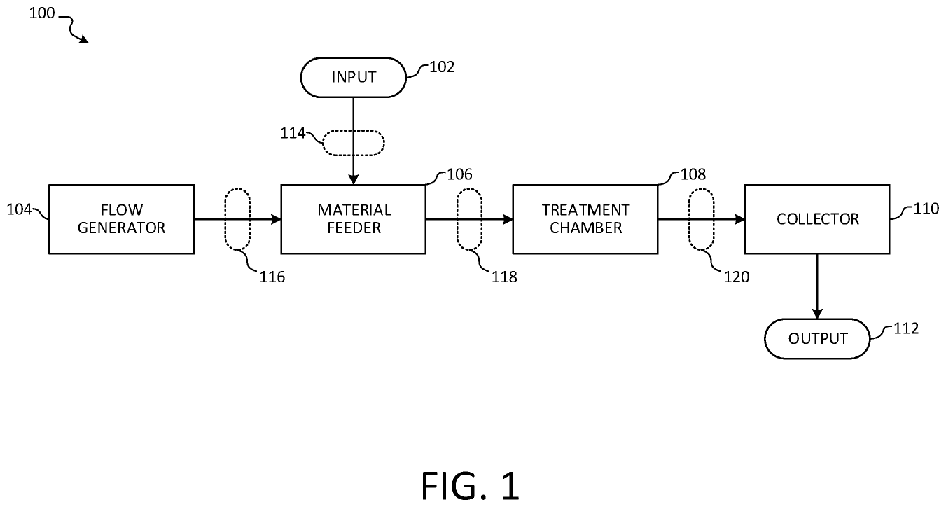

FIG. 1 illustrates an overview of an example system 100 for grain treatment according to aspects described herein. As illustrated, system 100 comprises input 102, flow generator 104, material feeder 106, treatment chamber 108, collector 110, output 112, and sensors 114-120. Thus, input 102 may be processed according aspects of system 100 to generate output 112, for example having reduced microorganisms, altered physical properties, and/or enhanced separation. For example, input 102 may be raw or processed grain, while output 112 may be treated material as described above.

Flow generator 104 may generate positive pressure in a fluid, such that the fluid may be used to convey input 102 through system 100. For example, flow generator 104 may comprise a fan or a pump. In examples, flow generator 104 further comprises one or more components for atmospheric control, for example to cool the fluid or to control the fluid composition. Such conditions may be detected by sensor 116 and managed accordingly. As an example, at least a part of the process may have an operating temperature range in which it is more efficient, such that flow generator 104 may maintain such an operating temperature. While flow generator 104 is illustrated at the beginning of system 100 (e.g., as may be the case when positive pressure is used), it will be appreciated that flow generator 104 may be positioned at alternative locations within the described process or, as another example, multiple such flow generators may be used. As an example, a flow generator may additionally or alternatively be positioned toward the end of system 100 (e.g., subsequent to collector 110) and may generate negative pressure.

While aspects herein are described in the context of pneumatic conveyance, it will be appreciated that the instant aspects may similarly be applicable to any of a variety of other method of conveyance. For example, input 102 may be conveyed using vibratory conveyance (including fluidized bed), auger type screw conveyors, chain or drag conveyors, or gravity conveyance, among other examples. The method of conveyance should agitate the material to expose substantially all surfaces within treatment chamber 108. For example, agitation may be obtained through fluidized beds or cascading plates that interrupt the flow of material. As another example, particles of input 102 may be dispersed or otherwise suspended within a flow generated by flow generator 104, such that input 102 is substantially in particle form (e.g., as compared to larger clumps). In addition to agitation, there may be a minimum flow rate (kg/min) at which the material should be conveyed so as to provide sufficient exposure time needed for germicidal and/or other effects.

Material feeder 106 may dispense input 102, at which point the dispensed input may be introduced into the flow generated by flow generator 104. For example, material feeder 106 may be a vibratory feeder that sifts or otherwise separates input 102, such that input 102 is separated into particles. For example, the vibratory feeder may comprise a tray, bin, or other material store. A motor or other vibrating means may cause material from the material store to pass through a screen or mesh. In other instances, input 102 need not be sifted, as may be the case depending on the material and/or if the material has been pre-processed.

As an example, material feeder 106 may be a vibratory feeder that sifts flour through a screen or mesh. Upon leaving material feeder 106, the sifted flour may become suspended in a stream of air (e.g., as may be generated by flow generator 104) and may flow into treatment chamber 108, for example via a tube.

In examples, material feeder 106 further comprises an ion generator, which may be used to generate ions having a positive and/or negative charge. For example, input 102 may have a pre-existing charge or a charge may be introduced as a result of the feeding process, such that the ion generator may substantially counteract the charge. In examples, the ion generator may be configured according to a detected charge of input 102 (e.g., as may be detected by sensor 114) or, as another example, may operate according to a predefined program or set of rules. For example, the ion generator may alternate between positive and negative ions according to a predetermined schedule. As another example, a set of rules may be used to configure the ion generator based on existing atmospheric conditions (e.g., temperature, humidity, etc.).

Thus, as a result of the ion generator, the material leaving material feeder 106 may have a substantially neutral charge. Returning to the above example, as a result of the nature of the dispersion provided by material feeder 106 (e.g., the sifter and/or use of an ion generator), the flour may be suspended substantially as particles within the flow, thereby enabling improved exposure of the flour within treatment chamber 108 (e.g., as compared to instances when the material may be clumpy or otherwise cling together). It will thus be appreciated that application of positive and/or negative ions may improve siftability of flour (e.g., by a vibratory feeder, using a bolting cloth, etc.).

It will be appreciated that an ion generator (and, in some examples, associated one or more sensors) may be used additionally or alternatively at any of a variety of other parts of system 100. For example, an additional ion generator may be placed prior to or after treatment chamber 108. It will be appreciated that any of a variety of other charge mitigation techniques may be used, for example grounding contacts or wires, among other examples.

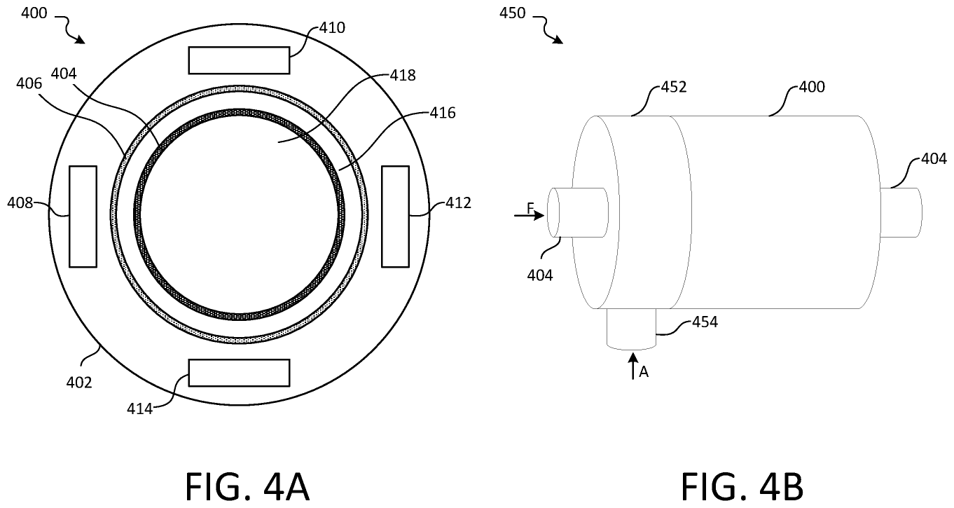

In examples, sensor 118 may be used to evaluate the quantity of material leaving material feeder 106, such that material feeder 106 may be configured accordingly. For example, it may be determined that material feeder 106 is dispensing a quantity of material that is above or beneath a predetermined threshold or outside of a predetermined range, such that material feeder 106 may be configured to dispense a greater or lesser amount of input 102 accordingly. Thus, sensor 118 may be a dispersion sensor, aspects of which are discussed below in greater detail with respect to FIG. 3.

The flow having material dispersed therein may enter treatment chamber 108. For example, the flow may pass through treatment chamber 108 via a tube (e.g., made of a UV-transparent material like quartz) or, in other examples, the flow may not be contained and may instead be more directly exposed within the treatment chamber.

In examples, treatment chamber 108 comprises one or more light sources. Example light sources include, but are not limited to, mercury-vapor lamps, light emitting diodes (LEDs), lasers, and/or pulsed xenon lamps, among other examples. Light sources of treatment chamber 108 may produce any of a variety of wavelengths, such light having UVC, UVB, and/or VUV wavelengths. It will be appreciated that, in some examples, multiple such light sources may be used and each light source need not have the same wavelength. As noted above with respect to flow generator 104, light sources of treatment chamber 108 may have an operating temperature or operating temperature range (e.g., outside of which germicidal efficacy and/or light source lifespan may diminish), such that flow generator 104 may maintain the requisite atmosphere accordingly.

In some instances, the interior wall of treatment chamber 108 may be coated or otherwise have a UV-reflective layer, such that light from the light sources that does not contact material is reflected back toward the flow rather than exiting the treatment chamber or being absorbed by the treatment chamber itself. For example, polished aluminum or polytetrafluoroethylene (PTFE) may be used as such a UV-reflective layer.

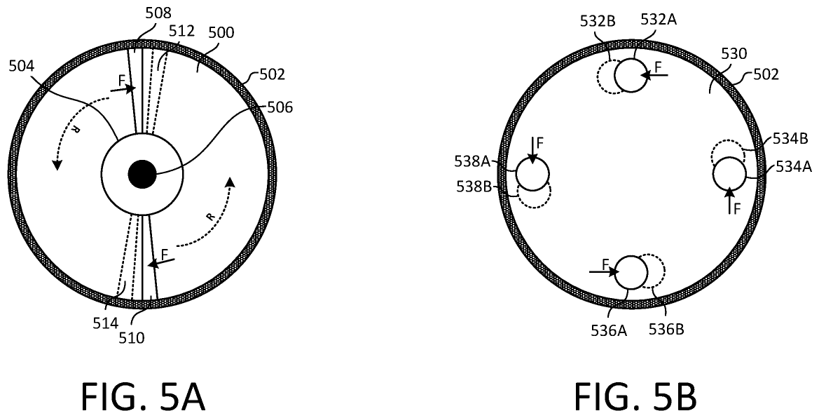

In some examples, light sources of treatment chamber 108 may introduce additional heat into the flow as it passes through treatment chamber 108. Accordingly, the tube through which the flow passes may be jacketed (e.g., using a quartz tube having an inner diameter greater than the outer diameter of the tube in which the flow travels) and cooled using a UV-transparent liquid, such as water. In some instances, UV-absorptive materials (e.g., plexiglass or most standard glass) may be used to effectively create viewing ports into treatment chamber 108 while eliminating exposure to harmful UV light. Additional examples of treatment chamber 108 are discussed in greater detail below with respect to FIGS. 4A and 4B.

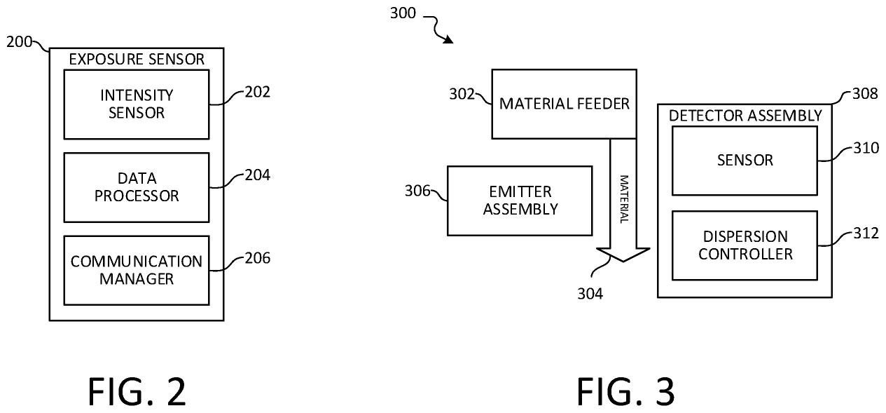

In examples, sensor 120 may evaluate a treatment metric associated with the flow, for example an intensity of UV light (e.g., in watts) to which the flow was exposed or an overall dose (e.g., in milliwatts per second or millijoules). Treatment chamber 108 may be configured accordingly, for example to increase the intensity of light sources therein or to adjust the amount of time a particle suspended within the flow spends within treatment chamber 108. Additional examples of such aspects are described below with respect to FIG. 2.

Collector 110 may cause the treated material particles suspended within the flow to settle out of the flow, such that they may be stored as output 112. In examples, collector 110 is heated, for example to maintain or increase the heat of the treated material. For example, output 112 may be heated for the purpose of odor reduction or mitigation. In another example, collector 110 may enable the treated material to gradually cool.

While aspects of system 100 are described in series, it will be appreciated that such aspects may be performed substantially contemporaneously, as may be the case when processing a flow in which new particles of input 102 are continually introduced (e.g., by material feeder 106) and settled out (e.g., by collector 110 as output 112). Further, while sensors 116, 114, 118, and 120 are described as collecting specific types of data and enabling specific operations associated therewith, it will be appreciated that any of a variety of additional or alternative sensors may be used. In other examples, fewer sensors may be used. For example, sensor 118 need not be the sole dispersion sensor. As an example, sensor 120 may further comprise such a dispersion sensor, such that the flow of the material through system 100 may be monitored at various points of the process.

It will be appreciated that while system 100 is illustrated as comprising one flow generator 104, one material feeder 106, one treatment chamber 108, and one collector 110, any number of such elements may be used in other examples. For instance, multiple treatment chambers may be used in series and/or in parallel. As an example, multiple treatment chambers may be used in serial when additional or different exposure is preferred than can be provided by a single treatment chamber. As another example, multiple treatment chambers may be used in parallel when a single treatment chamber would otherwise be a bottleneck, such that a flow may be divided among the multiple treatment chambers and, in some examples, rejoined by collector 110.

FIG. 2 illustrates an overview of an example exposure sensor 200 according to aspects described herein. As illustrated, exposure sensor 200 comprises intensity sensor 202, data processor 204, and communication manager 206. In examples, intensity sensor 202 is capable of detecting light intensity in one or more wavelengths. For example, intensity sensor 202 may be selected or configurable to detect intensity of a specific wavelength. As another example, sensor 202 may output data associated with multiple wavelengths, such that the data may be filtered (e.g., by data processor 204) to identify an intensity of one or more wavelengths therein.

Accordingly, data processor 204 may process output of intensity sensor 202 to determine a detected intensity of one or more wavelengths. In examples, the wavelengths are associated with one or more light sources of a treatment chamber, such as treatment chamber 108 discussed above with respect to FIG. 1. In examples, data processor 204 further processes the detected intensity according to a duration associated with the exposure. In examples, the intensity may vary with time (e.g., as may be the case as intensity sensor 202 moves within an environment and/or as an output of a light source changes), such that data processor 204 determines a total exposure for the duration accordingly. As noted above, the resulting exposure may be in the form of milliwatts per second or millijoules, among other examples. While example outputs are described, it will be appreciated that any of a variety of outputs may be generated by data processor 204. For example, an average, minimum, and/or maximum intensity for a given duration may be generated or, as another example, a resulting exposure determination may be separated according to wavelength or one or more ranges of wavelengths.

Exposure sensor 200 is further illustrated as comprising communication manager 206, which may communicate with a computing device. For example, communication manager 206 may communicate using any of a variety of wired and/or wireless forms of communication, including, but not limited to, Ethernet, a universal serial bus (USB) connection, Bluetooth, and/or Wi-Fi, among other examples.

Thus, exposure sensor 200 may be a device that can be passed through a treatment chamber, thereby detecting the exposure that a particle traveling a similar path as exposure sensor 200 experiences. As another example, intensity sensor 202 may be fixed and/or remote from data processor 204. Data processor 204 may interpolate, estimate, or simulate an exposure based on one or more intensity measurements from intensity sensor 202, for example using an exposure duration or an estimated path, among other examples.

While exposure sensor 200 is illustrated as having a single intensity sensor 202, multiple intensity sensors may be used in other examples, for example as may be positioned at various locations within a treatment chamber. Finally, it will be appreciated that exposure sensor 200 need not be a standalone device, such that the described functionality may alternatively or additionally be implemented by any of a variety of other devices.

FIG. 3 illustrates an overview of an example block diagram 300 for dispensing material using a dispersion controller according to aspects described herein. As illustrated, diagram 300 comprises material feeder 302, emitter assembly 306, and detector assembly 308. In some instances, emitter assembly 306 and/or detector assembly 308 may be integrated into material feeder 302 and are depicted separately in FIG. 3 for illustrative purposes. Material feeder 302 may be similar to material feeder 106 discussed above with respect to FIG. 1.

As illustrated, material feeder 302 dispenses material 304, which is depicted by a downward arrow to illustrate that it may fall as a result of gravity. It will be appreciated that similar aspects are applicable in instances where the dispensed material is additionally or alternatively propelled by any of a variety of other forces (e.g., a pneumatic force, as may be generated by flow generator 104 discussed above with respect to FIG. 1). Regardless, emitter assembly 306 is positioned substantially opposed to detector assembly 308, such that at least a part of material 304 passes between emitter assembly 306 and detector assembly 308.

In examples, emitter assembly 306 comprises an infrared (IR) light source. It will be appreciated that any of a variety of wavelengths may be used. An IR light source may be used in some instances, for example when the particle size of material 304 is substantially similar to the wavelength of IR. In such instances, particles passing in front of emitter assembly 306 may interfere with emitted IR photons, thereby reducing or inhibiting their detection by detector assembly 308.

Detector assembly 308 is illustrated as comprising sensor 310 and dispersion controller 312. Sensor 310 may detect at least some of the emission generated by emitter assembly 306. Thus, as material 304 passes between emitter assembly 306 and detector assembly 308, sensor 310 may detect the degree to which such emissions are inhibited, such that the flow of the material may be quantified. While block diagram 300 is illustrated as comprising a single sensor 310, it will be appreciated that, in some examples, emitter assembly 306 may comprise multiple light sources, such that detector assembly 308 may similarly comprise multiple corresponding sensors. It will be appreciated that the ratio of emitters to sensors need not be 1:1, and any number of such components may be used.

Dispersion controller 312 may process the output of sensor 310 to determine how much material is being dispersed by material feeder 302. For example, dispersion controller 312 may process an emission detected by sensor 310 in view of a known emission of emitter assembly 306 to determine a percentage that was blocked by material 304. In examples, a calibration table or calibration model may be used to interpret output of sensor 310. The calibration table or calibration model may be associated with one or more material types, such that different computations may be used for different materials. In some instances, dispersion controller 312 may be configured to maintain a substantially consistent flow of material (e.g., within a predetermined threshold or range), such that dispersion controller 312 may configure material feeder 302 accordingly (e.g., to increase or decrease output based on detected dispersion), thereby forming a feedback loop.

FIG. 4A illustrates a cross section of an example treatment chamber 400 according to aspects described herein. For example, treatment chamber 400 may be similar to treatment chamber 108 discussed above with respect to FIG. 1.

As illustrated, treatment chamber 400 is comprised of enclosure 402, flow tube 404, jacket tube 406, and light sources 408, 410, 412, and 414. Enclosure 402 has an exterior wall and an interior wall. As noted above, the interior wall of enclosure 402 may have a UV-reflective coating or layer. As another example, enclosure 402 may itself at least partially be manufactured from a UV-reflective material. Enclosure 402 should protect leakage of UV light (e.g., as may be emitted by light sources 408, 410, 412, and 414) and, in some examples, should also maintain atmospheric conditions needed for treatment.

Light sources 408, 410, 412, and 414 may each be a mercury-vapor lamp, LED, laser or pulsed xenon lamp, among other examples. In some instances, light sources 408, 410, 412, and 414 may each emit the same wavelength or may emit different wavelengths. In examples, light sources 408, 410, 412, and 414 may each be capable of producing light in one or more wavelengths within the UV spectrum (10 nm-400 nm). Example wavelengths include, but are not limited to: the UVC range for germicidal effects (100 nm-280 nm), the VUV range (10 nm-200 nm) for photocatalytic and ozone producing effects, and/or the UVA/UVB range (280 nm-400 nm) for autofluorescence effects. While example ranges are given, it will be appreciated that a single wavelength or a specific subset of wavelengths may be used. For instance, one or more such wavelengths may be used to achieve the desired germicidal, catalytic, and/or autofluorescence effects, while reducing the heat that is imparted on the material as part of the process. Thus, light sources 408, 410, 412, and/or 414 may generate UVC light with the intensity required to eliminate living and sporulated microorganisms from the surface of raw and processed grains and ingredients (e.g., as may be passed through flow tube 404).

While treatment chamber 400 is illustrated as having four light sources in an example configuration, it will be appreciated that any number of light sources in any of a variety of configurations may be used according to aspects described herein. For example, light sources need not be opposed from one another and may not span the entire length of the treatment chamber. Rather, light sources may be at least partially staggered in other examples. Light sources 408, 410, 412, and 414 may be positioned within treatment chamber 400 such that light emitted therefrom is directed toward flow tube 404. As noted above, the UV reflectivity of enclosure 402 may further redirect light toward flow tube 404 if such emitted light is not absorbed by material within flow tube 404.

Tubes 404 and 406 may each be comprised of a UV-transparent material, such as quartz. As illustrated, the outer diameter of flow tube 404 is smaller than the inner diameter of jacket tube 406, thereby forming cavity 416. As discussed above, coolant may flow through cavity 416, thereby cooling the content of flow tube 404 and/or light sources 408, 410, 412, and 414. For example, a UV-transparent coolant may be used, such as water. It will be appreciated that any of a variety of additional or alternative cooling techniques may be used. For example, air may be used as a coolant. As another example, air may flow through enclosure 402 itself, examples of which are discussed below with respect to FIG. 4B.

The interior of flow tube 404 forms cavity 418 through which material may travel for treatment (e.g., as particles suspended in a fluid, as may be generated by flow generator 104 and material feeder 106 discussed above with respect to FIG. 1). In examples, flow tube 404 is doped or coated with TiO₂. For example, a layer of TiO₂ may be deposited on the interior of flow tube 404. When irradiated by one or more of light sources 408, 410, 412, and/or 414, the TiO₂ acts as a photocatalyst, such that at least a part of the emitted radiation causes an oxidation reaction. Such oxidation may improve or maintain the cleanliness of flow tube 404 (e.g., thereby reducing or preventing buildup of material thereon). Further, the oxidation may have germicidal effects in addition to those provided by UV light emitted by one or more of light sources 408, 410, 412, and/or 414. Additionally, the oxidation may reduce or inhibit odor that may result from the treatment process, such as oxidizing one or more thiol groups that form therefrom. In some instances, the oxidation may facilitate aging of the material within flow tube 404, which may be desirable in some instances. In an example, a subset of light sources 408, 410, 412, and 414 emits the requisite wavelength(s) to cause the TiO₂ coating to act as a photocatalyst, such that the subset of light sources may be selectively powered when such behavior is desired.

FIG. 4B illustrates a side view 450 of an example treatment chamber 400 and atmospheric control assembly 452 according to aspects described herein. In examples, light sources (e.g., light sources 408, 410, 412, and 414 in FIG. 4A) within treatment chamber 400 may have an operating temperature range, such that atmospheric conditions may be controlled using atmospheric control assembly 452 accordingly. As illustrated, flow tube 404 passes through atmospheric control assembly 452 and into treatment chamber 400, thereby enabling flow F (e.g., as may be generated by a first flow generator, such as flow generator 104 discussed above) to be treated by treatment chamber 400 according to aspects described herein. Atmospheric control assembly 452 comprises intake 454, through which cooled air may pass (e.g., as may be generated by a second flow generator), as illustrated by arrow A. The cooled air may then be directed through enclosure 402, thereby cooling one or more light sources therein.

It will be appreciated that a condition within flow tube 404 may be controlled (e.g., by the first flow generator) separately from or in conjunction with a condition within enclosure 402 (e.g., as may be controlled by the second flow generator) more generally. For instance, the first flow generator may be subsequent to treatment chamber 400 and may generate negative pressure, thereby pulling flow F through flow tube 404 (e.g., which may thereby incorporate material dispensed by a material feeder, such as material feeder 106), while the second flow generator may generate positive pressure, thereby pushing cool air A through enclosure 402 via intake 454 of atmospheric control assembly 452. FIG. 4B is provided as an example in which jacket tube 406 is omitted, however it will be appreciated that similar aspects may be applied in instances where jacket tube 406 is included (as was described above with respect to FIG. 4A). Further, atmospheric control need not be limited to cool air and it will be appreciated that any of a variety of other cooling techniques may be used.

As noted above, atmospheric conditions may be maintained for consistency and efficacy of the UV light treatment in some examples. For instance, short wavelength VUV light will produce ozone under standard atmospheric conditions and the presence of molecular oxygen O₂. In a nitrogen-rich environment, VUV light will react directly with the treated material during photocatalytic chemical reactions. Thus, atmospheric conditions may be maintained to control the desired production of ozone and other photocatalytic products. Atmospheric oxygen can be depleted by purging an airtight vessel with nitrogen generated on site using a nitrogen generator. Other inert or reactive gasses may be used to produce specific chemistries and intended outcomes.

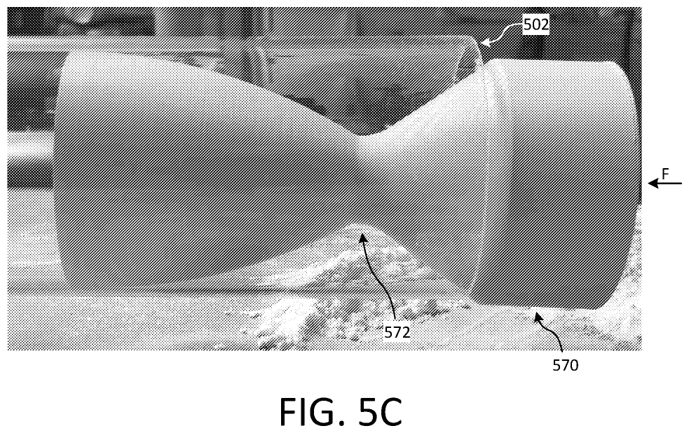

FIGS. 5A-5C illustrate overviews of example flow control assemblies that may be used to control the flow of material into a treatment chamber according to aspects described herein. For example, a flow control assembly may be placed at the entrance of and/or within a treatment chamber (e.g., treatment chamber 108 in FIG. 1 or flow tube 404 of treatment chamber 400 in FIG. 4A) to affect material flow therein.

With reference to FIG. 5A, flow control assembly 500 is rotatably coupled to shaft 506 by bearing 504, thereby enabling axial rotation R of angular slits 508 and 510 about shaft 506. Flow control assembly 500 is mechanically coupled to flow tube 502, aspects of which may be similar to flow tube 404 and are therefore not re-described below in detail.

Flow control assembly 500 further comprises angular slits 508 and 510, through which flow passes (e.g., as may be generated by a flow generator such as flow generator 104 in FIG. 1). Openings 512 and 514 are illustrated using dash lines to indicate that they are on the opposite side of flow control assembly 500. Thus, as flow F passes through slits 508 and 510 toward openings 512 and 514, respectively, rotational movement R is induced, thereby causing flow control assembly 500 to rotate about shaft 506. Further, slits 508 and 510 induce vortices in the flow, which may have different starting locations by virtue of the rotation of slits 508 and 510. While flow control assembly 500 is described in an example where rotation is induced by the flow itself, it will be appreciated that, in other examples, shaft 506 may further be coupled to a motor or other mechanism for increasing, decreasing, stopping, or otherwise controlling rotation of flow control assembly 500 accordingly.

Vortices induced by a flow control assembly according to aspects described herein may cause particles within the flow to travel in closer proximity to the wall of flow tube 502 (and, by extension, light sources of the treatment chamber), thereby increasing exposure to radiation within the treatment chamber (as compared to an instance where a particle is closer toward the center of the flow tube and thus farther from a light source).

Additionally, rotation induced by flow control assembly 500 may cause a particle to take a longer path than would otherwise be the case if the particle travelled along a substantially straight path through the flow tube. As a result, a particle may receive a similar amount of exposure in a shorter flow tube than would otherwise be needed in an instance where the path through the flow tube is substantially straight.

Turning to FIG. 5B, flow control assembly 530 is similarly illustrated in flow tube 502. However, as compared to flow control assembly 500, flow control assembly 530 is stationary. Flow control assembly 530 may be retained using a friction fit within flow tube 502. As another example, flow control assembly 530 may alternately have a diameter that is larger than flow tube 502 and a groove in which flow tube 502 may be placed. Thus, it will be appreciated that a flow tube may be positioned at any of a variety of locations and any of a variety of retention techniques may be used.

Flow control assembly 530 is illustrated as having apertures 532A, 534A, 536A, and 538A. Each aperture has an associated opening 532B, 534B, 536B, and 538B on the opposite side of flow control assembly 530, as illustrated by the dashed circles. Thus, similar to flow control assembly 500, as flow passes through apertures 532A, 534A, 536A, and 538A, vortices are formed. While flow control assembly 530 is illustrated as having four substantially circular apertures, it will be appreciated that any number and/or shape of apertures may be used.

FIG. 5C illustrates a side view of an example flow control assembly 570. Flow control assembly 570 has a single aperture 572 and is retained within flow tube 502. As compared to flow control assemblies 500 and 530, flow control assembly 570 does not generate discrete vortices in which particles are suspended. Rather, flow control assembly 570 may generate a more turbulent flow that disperses particles within the flow as it passes through aperture 572, such that the particles are more thoroughly “dissolved” within the flow.

While example geometries are illustrated and described with respect to flow control assemblies 500, 530, and 570, it will be appreciated that any of a variety of other geometries may be used. For example, additional or fewer apertures, apertures of different shapes, and/or slits having different angles may be used in other examples. Further, a single flow tube need not be limited to a single flow control assembly. For example, flow control assembly 500 or 530 may first be used to induce vortices in a flow for a subpart of a treatment chamber, while flow control assembly 570 may be used to subsequently re-disperse particles of the flow for another subpart of the treatment chamber.

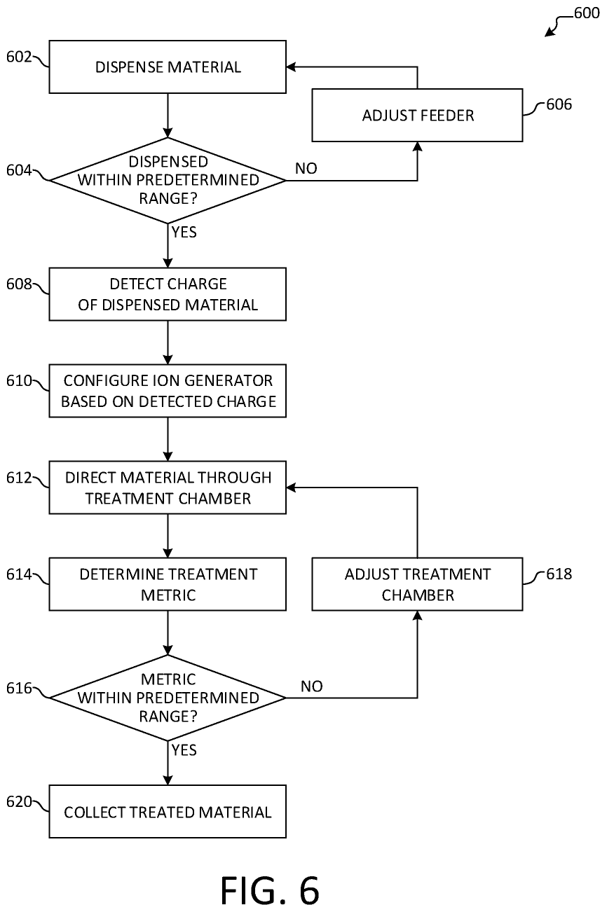

FIG. 6 illustrates an overview of an example method 600 for treating grain according to aspects described herein. In examples, aspects of method 600 may be performed in conjunction with aspects of system 100 discussed above with respect to FIG. 1.

As illustrated, method 600 begins at operation 602, where material is dispensed. For example, the material may be dispensed into a flow generated by a flow generator, such as flow generator 104 discussed above with respect to FIG. 1. The material may be dispensed by a material feeder (e.g., material feeder 106), which may be configured according to output of a dispersion controller (e.g., dispersion controller 312 in FIG. 3) or any of a variety of other sensors (e.g., sensor 114).

Flow progresses to determination 604, where it is determined whether the dispensed material is within a predetermined range. For example, the determination may be made based on an indication generated by a dispersion controller (e.g., dispersion controller 312). In examples, the predetermined range applied at determination 604 may vary according to environmental conditions and/or the material that is dispensed, or may be consistent. For instance, a different range may be used for processed grains as compared to raw grains. As another example, the same range may be used regardless of environmental conditions, as the dispersion controller may monitor the actual dispersion of the material, such that the feeder may be configured (e.g., at operation 606) to account for variations in environment conditions, thereby maintaining a substantially consistent feed rate of the material. Determination 604 may comprise any of a variety of determinations and need not be limited to a predetermined range. For example, a threshold, set of rules, and/or model may be used, among other examples.

If it is determined that the material was not dispensed within the predetermined range, flow branches “NO” to operation 606, where the material feeder is adjusted. For example, if it is determined that the material was dispensed below a predetermined threshold, the rate with which the material feeder dispenses material may be increased. Similarly, if the material was dispensed above a predetermined threshold, the rate with which the material feeder dispenses material may be decreased. In some examples, operations 602, 604, and 606 are performed iteratively, so as to form a closed feedback loop. In other examples, operation 606 may comprise configuring the material feeder according to a stored configuration, for example associated with a set of environmental conditions. Thus, it will be appreciated that any of a variety of techniques may be used to configure a material feeder according to aspects of the present disclosure.

Returning to determination 604, if it is determined that the material was dispensed within the predetermined range, flow instead branches “YES' to operation 608, where a charge of the dispensed material is determined. As noted above, the material may have a positive, neutral, or negative charge, which may cause the material to clump or, as another example, to stick on aspects of the instant system. Accordingly, at operation 610, an ion generator is configured based on the detected charge. For example, the ion generator may be configured to generate positive or negative ions. In the instance the detected charge is neutral, the ion generator may be configured to generate no ions or may be disabled, among other examples. In some instances, operation 610 further comprises configuring the rate at which ions are generated, as may be associated with a magnitude of the charge detected at operation 608. Thus, operations 608 and 610 may dynamically generate ions according to changing electrostatic conditions in the material as it is dispensed.

Flow progresses to operation 612, where the material is directed through the treatment chamber. For example, the material may travel through a flow tube of the treatment chamber, as discussed above with respect to treatment chamber 108 in FIG. 1 and treatment chamber 400 in FIGS. 4A and 4B. In some instances, operation 612 may comprise controlling the flow using one or more flow control assemblies, examples of which were discussed above with respect to FIGS. 5A-5C.

At operation 614, a treatment metric is determined. Example treatment metrics include, but are not limited to, an intensity of the treatment, a duration of the treatment, or an exposure of the treatment (e.g., which may be measured as intensity over time). For example, the treatment metric may be determined based at least in part on an exposure sensor, such as exposure sensor 200 discussed above with respect to FIG. 2. In examples, the treatment metric is determined with respect to a discrete amount of material or may be monitored on a substantially continuous basis. It will be appreciated that operation 614 is not limited to a single treatment metric and that any number of alternative or additional treatment metrics may be used according to aspects described herein.

Flow progresses to determination 616, where it is determined whether the metric is within a predetermined range. Similar to determination 604, determination 616 may be dependent on the type of material and/or environmental conditions. In some instances, the treatment metric may vary as a result of aspects of the system with which method 600 is performed. For example, a light source may gradually grow less intense with time, such that an associated treatment metric may gradually change and ultimately fall outside the predetermined threshold that is applied at determination 616. In instances where multiple treatment metrics are used, determination 616 may comprise multiple evaluations and/or generating a weighted treatment metric from multiple constituent metrics. Thus, it will be appreciated that any of a variety of treatment metrics and associated evaluations may be used. For example, a threshold, set of rules, and/or model may be used, among other examples.

Accordingly, if it is determined that the metric is not within the predetermined range, flow branches “NO” to operation 618, where the treatment chamber is adjusted. Example adjustments include, but are not limited to, enabling or disabling one or more light sources, adjusting light source intensity, and adjusting a flow control assembly. For example, a flow control assembly may be adjusted to spin faster or slower, thereby controlling the travel time for particles through the treatment chamber. While example adjustments are described, it will be appreciated that any of a variety of other adjustments may be made based on the treatment metric determined at operation 614. As another example, a flow may be diverted into a different or additional chamber.

Thus, as a result of one or more adjustments made at operation 618, subsequent particles may be treated according to operations 612, 614, and 616 based on such adjustments. Similar to aspects discussed above with respect to determination 604, operations 612, 614, 616, and 618 may, in some examples, form a closed feedback loop such that adjustments are performed as needed to maintain one or more treatment metrics within a predetermined range, among other examples.

Returning to determination 616, if it is determined that the treatment metric is within the predetermined range, flow instead branches “YES” to operation 620, where the treated material is collected. In examples, the treated material is collected by a collector, such as collector 110 discussed above with respect to FIG. 1. For example, the now-treated material may settle out of the flow and may be stored accordingly. Method 600 terminates at operation 620.

While aspects of method 600 are described sequentially, it will be appreciated that such aspects may be performed substantially contemporaneously, as may be the case to process a flow in which new particles of input 102 are continually dispensed at operation 602 and treated particles are settled out at operation 620. In such examples, determination 604 and 616 and associated operations 606 and 618 may similarly be performed contemporaneously, periodically, or in any of a variety of other instances, to manage the feed rate and treatment applied by method 600 accordingly.

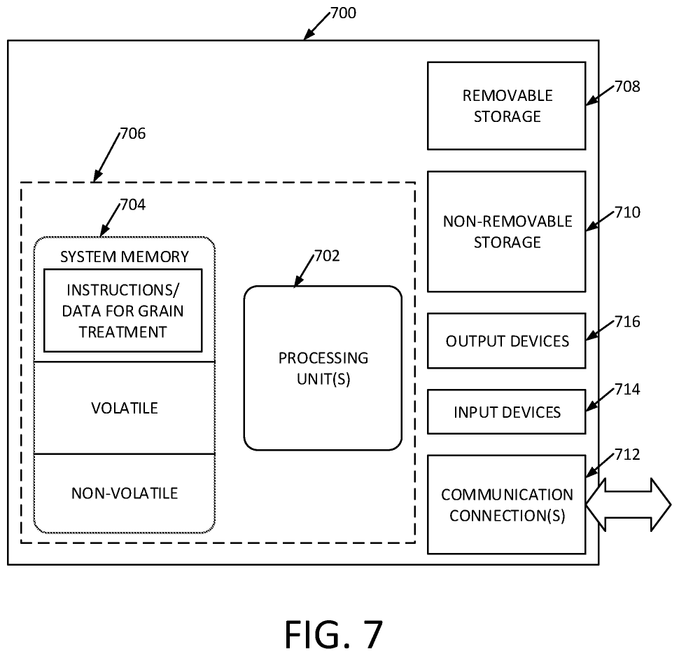

FIG. 7 illustrates an example of a suitable operating environment 700 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 700 typically may include at least one processing unit 702 and memory 704. Depending on the exact configuration and type of computing device, memory 704 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 7 by dashed line 706. Further, environment 700 may also include storage devices (removable, 708, and/or non-removable, 710) including, but not limited to, magnetic or optical disks or tape. Similarly, environment 700 may also have input device(s) 714 such as a keyboard, mouse, pen, voice input, etc. and/or output device(s) 716 such as a display, speakers, printer, etc. Also included in the environment may be one or more communication connections, 712, such as LAN, WAN, point to point, etc.

Operating environment 700 may include at least some form of computer readable media. The computer readable media may be any available media that can be accessed by processing unit 702 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 700 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 704. While executing on the processing unit 702, program modules (e.g., applications, Input/Output (I/O) management, and other utilities) may perform processes including, but not limited to, one or more of the stages of the method illustrated in FIG. 6, or operational aspects discussed above with respect to FIG. 1, 2, or 3, for example.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 700 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A device for treating material, comprising:
an enclosure;
an ultraviolet light source secured within the enclosure; and
a tube operationally associated with the enclosure to convey the material through the enclosure, thereby exposing the material to the ultraviolet light source.

2. The device of claim 1, wherein:
an interior of the enclosure has a UV-reflective layer; or
the enclosure is at least partially UV-reflective.

3. The device of claim 1, wherein:
the tube is a flow tube; and
the device further comprises a jacket tube operationally associated with the enclosure, wherein the flow tube has an inner diameter greater than an outer diameter of the flow tube and the flow tube is disposed within the jacket tube thereby forming a cavity between the jacket tube and the flow tube.

4. The device of claim 1, wherein the tube is a quartz tube.

5. The device of claim 4, wherein:
the quartz tube comprises a layer of titanium dioxide on an interior surface; and
the ultraviolet light source is capable of emitting UVB light to cause the layer of titanium dioxide to act as a photocatalyst.

6. The device of claim 1, wherein the material is processed grain.

7. A device for dispensing material, comprising:
a material store;
a screen to disperse material from the material store;
a motor to induce vibration in the material store, thereby causing at least some of the material to be dispensed through the screen; and
an ion generator configured to emit charged ions to the dispensed material.

8. The device of claim 7, further comprising a charge sensor, wherein a controller of the device configures the ion generator according to a charge detected by the charge sensor.

9. The device of claim 7, wherein the controller configures the ion generator to:
emit a positive ion when a negative charge is detected; and
emit a negative ion when a positive charge is detected.

10. The device of claim 7, wherein a controller of the device configures the ion generator to emit a sequence of positive ions and a negative ions according to a predetermined schedule.

11. A method for treating material, the method comprising:
dispensing material from a material store;
treating the dispensed material by conveying the dispensed material through a treatment chamber, wherein the dispensed material is suspended within a fluid passing through a flow tube of the treatment chamber and the treatment chamber comprises a light source; and
collecting the treated material by settling out the treated material from the fluid.

12. The method of claim 11, further comprising:
detecting a charge of the dispensed material;
when the charged ions to the dispensed material;

13. The method of claim 11, further comprising:
determining a treatment metric associated with the treated material; and
adjusting a configuration of the treatment chamber based on the determined treatment metric.

14. The method of claim 13, wherein the treatment metric is an exposure to the light source of the treatment chamber.

15. The method of claim 13, wherein:
the treatment chamber further comprises a flow control assembly; and
adjusting the configuration of the treatment chamber comprises adjusting a configuration of the flow control assembly.
